(19) United States
(12) Patent Application Publication
(10) Pub. No.: US 2013/0335448 A1
(43) Pub. Date: Dec. 19, 2013

(54) METHOD AND APPARATUS FOR PROVIDING VIDEO CONTENTS SERVICE, AND METHOD OF REPRODUCING VIDEO CONTENTS OF USER TERMINAL

(71) Applicant: ELECTRONICS AND TELECOMMUNICATIONS RESEARCH INSTITUTE, Daejeon (KR)

(72) Inventors: Seung Chul KIM, Daejeon (KR); Soon Choul KIM, Daejeon (KR); Jung Hak KIM, Daejeon (KR); Bum Suk CHOI, Daejeon (KR); Jeoung Lak HA, Daejeon (KR); Young Ho JEONG, Daejeon (KR); Jin Woo HONG, Daejeon (KR)

(73) Assignee: Electronics and Telecommunications Research Institute, Daejeon (KR)

(21) Appl. No.: 13/769,020

(22) Filed: Feb. 15, 2013

(30) Foreign Application Priority Data
Jun. 15, 2012 (KR) 10-2012-0064225

(51) Int. Cl. G06T 11/60

(52) U.S. Cl. CPC G06T 11/60
USPC 345/633

(57) ABSTRACT

Disclosed is a method of providing a video contents service including calculating conversion information indicating a relation between a projection area and an area corresponding to the projection area in order to project video contents on the area corresponding to the projection area which is a partial area within a prepared image in a user image photographed by a user terminal; and transmitting the calculated conversion information to the user terminal.

### CROSS-REFERENCE TO RELATED APPLICATIONS

This application claims priority to and the benefit of Korean Patent Application No. 10-2012-0064225 filed in the Korean Intellectual Property Office on Jun. 15, 2012, the entire contents of which are incorporated herein by reference.

### TECHNICAL FIELD

The present invention relates to an Internet video service, and more particularly to, a method and an apparatus for providing a video contents service for providing an image generated by synthesizing a real image and video contents based on an augmented reality technology, and a method of reproducing video contents of a user terminal.

### BACKGROUND ART

Augmented reality makes a computer graphic-based virtual object or information look like it is in an original real environment by synthesizing a real image photographed by a camera and the computer graphic-based virtual object or information. An augmented reality technology was introduced in the early 1990's and has been actively researched and developed, and applications thereof have been attempted in various fields. In recent years, as a computer graphic technology is highly advanced and hardware/software for a portable terminal and various sensing technologies are developed, an augmented reality service becomes more common.

A main object of a position-based augmented reality service in the related art is to transfer information, and the position-based augmented reality service has provided a service graphically showing various information in a camera image containing a particular place or object (or a building or a person) in a real world by using a position, a direction, motion information and the like using a GPS sensor or an acceleration sensor.

Meanwhile, as an Internet video service such as YouTube is activated and a portable terminal providing an Internet access function through a wireless LAN or a mobile communication network becomes more common, demands for an Internet media service without regard to a time and place continue to increase. A service by which a user of a portable terminal can directly generate position-based contents in a field and share the generated position-based contents with other users is currently designed.

### SUMMARY OF THE INVENTION

The present invention has been made in an effort to provide a method and an apparatus for providing a video contents service for providing an image generated by synthesizing a real image and video contents based on an augmented reality technology, and a method of reproducing video contents of a user terminal.

An exemplary embodiment of the present invention provides a method of providing a video contents service including: calculating conversion information indicating a relation between a projection area and an area corresponding to the projection area in order to project video contents on the area corresponding to the projection area which is a partial area within a prepared image in a user image photographed by a user terminal; and transmitting the calculated conversion information to the user terminal.

The prepared image in advance may be an image generated by photographing a particular subject, and the projection area may be at least a partial area of the subject.

The user image may be an image generated by photographing the subject, and the area corresponding to the projection area may be an area corresponding to the partial area of the subject in the user image.

Photographing position information and photographing direction information of the image generated by photographing the subject may be prepared in advance, and the method may further include receiving position information and direction information of the user terminal from the user terminal; and determining whether the area corresponding to the projection area exists in the user image by comparing position information and direction information of the user terminal with photographing position information and photographing direction information.

The method may further include searching for video contents to be projected on the subject.

Information on the projection area may be prepared in advance.

The method may further include receiving feature information of the user image from the user terminal, wherein the calculating of the conversion information may include calculating the conversion information based on the feature information of the user image and feature information of the projection area.

The conversion information may be a conversion matrix.

Another exemplary embodiment provides an apparatus for providing a video contents service including: a conversion information calculator configured to calculate conversion information indicating a relation between a projection area and an area corresponding to the projection area in order to project video contents on the area corresponding to the projection area, which is a partial area within a prepared image in advance in a user image photographed through a user terminal; and a communication unit configured to transmit the calculated conversion information to the user terminal.

The apparatus may further include a database configured to store a subject image, photographing position information, and photographing direction information; and a projection area searching unit configured to search for a subject image where the area corresponding to the projection area exists in the user image and the projection area in the database by comparing the position information and the direction information of the user terminal received from the user terminal with the photographing position information and the photographing direction information.

The database may further store information on the projection area.

The conversion information calculator may calculate the conversion information based on feature information of the user image received from the user terminal and feature information of the projection area.

Yet another exemplary embodiment provides a method of reproducing video contents of a user terminal, the method including: obtaining an image by photographing a particular subject; receiving conversion information indicating a relation between a projection area which is a partial area of the subject within an image of a prepared subject in advance and an area corresponding to the projection area within the obtained image; and synthesizing the obtained image and video data in order to project video contents on the area corresponding to the projection area within the obtained image by using the conversion information.

The method may further include transmitting position information and direction information of the user terminal.

The method may further include extracting feature information from the obtained image and transmitting the extracted feature information, wherein the conversion information may be calculated based on feature information of the obtained image and feature information of the projection area.

The synthesizing of the obtained image and the video data may include calculating the area corresponding to the projection area from the obtained image by using the conversion information and deforming the video data to overlay the deformed video data with the area corresponding to the projection area.

According to exemplary embodiments of the present invention, it is possible to provide an image generated by synthesizing a real image and video contents to a user.

It is possible to provide an additional interest to a demander of an Internet-based video contents service and provide effective promotional and advertising opportunities to an owner or a manager of a subject on which contents are projected by projecting conventionally generated various contents on a particular subject in a real world.

A video contents producer can diversify and activate a corresponding contents service by photographing a new subject on which video contents of the video contents producer are projected and providing a subject image and associated information to a service provider.

A service demander can also obtain an interesting user experience by photographing a new subject on which video contents are projected and providing a subject image and associated information to a service provider.

According to the present invention, it is possible to expect an effective promotion for various types of buildings and brands by providing a virtual screen including a wall in a street or a building in a city as a subject.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a video contents service according to an exemplary embodiment of the present invention.

FIG. 2 illustrates a configuration of a video contents providing apparatus according to an exemplary embodiment of the present invention.

FIG. 3 illustrates a configuration of a user terminal according to an exemplary embodiment of the present invention.

FIG. 4 is a flowchart illustrating a video contents service providing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

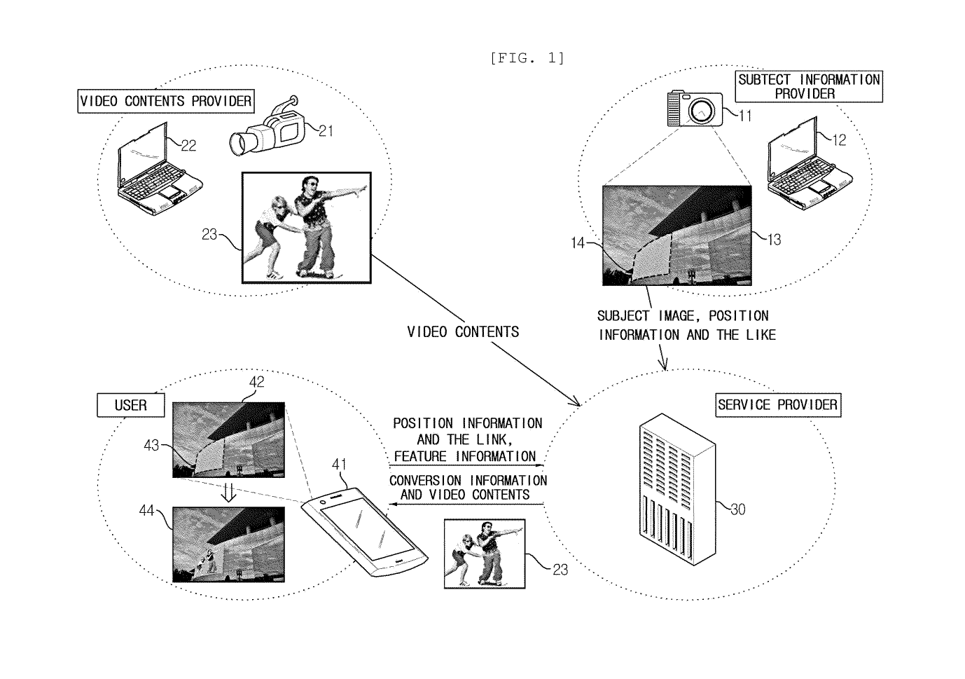

FIG. 1 illustrates a video contents service according to an exemplary embodiment of the present invention.

Referring to FIG. 1, a subject information provider provides an image of a subject on which video contents are projected and associated information to a service provider, a video contents provider provides the video contents to the service provider, and the service provider provides a video contents service according to the present invention to a user.

The subject information provider photographs a subject by a camera 11 to obtain a subject image 13. At this time, it is preferable that the camera 11 has a function of obtaining a position and a direction, an angle of the camera, and information on a distance from the subject while photographing the subject. The subject may be an object which is fixed to any position or an object such as a building, a road or the like of which a position is specified. The subject information provider determines an area on which the video contents are projected in the subject image 13. In the following description, the area on which the video contents are projected in the subject image is referred to as a “projection area”. In the following description, “subject information” contains a subject image, a position, a direction, a distance, information on a camera angle while photographing the subject, and information on the projection area. The projection area may be a partial area of the subject and an entire area of the subject shown in the subject image. When the number of subjects is two or more, the projection area may exist over two subjects. For example, the subject is any building and a projection area 14 is a partial wall surface of the building in FIG. 1. The information on the projection area may be expressed using coordinate values within the subject image. The subject information provider provides subject information to a service provider 30 by using a terminal 12 such as a computer and the like.

The subject information provider may be a person who owns or manages the corresponding subject. However, for activation of the service, the service provider may obtain images of several subjects and associated information and directly supply the subject information. The video contents provider may also select a subject suitable for its own contents to obtain corresponding subject information and provide the subject information to the service provider. The user may also obtain a favorite place or subject information of a suitable subject on which video contents are projected and provide the place and the subject information. In short, a main agent providing the subject information can be anyone in the present invention, and there is no technically meaningful difference by the main agent.

The video contents provider produces video contents by photographing a video by a camcorder 21 or editing the video, and provides a video file to the service provider 30 through the terminal 22 such as a computer and the like. Of course, the video contents provider may edit the conventional video contents without directly photographing the video or directly provide the conventional video contents to the service provider 30. FIG. 1 shows video contents 23 provided by the video contents provider.

The service provider has a server 30 for providing a service. The server 30 stores subject information received from subject information providers and video contents received from video contents providers in a database and manages the stored subject information and video contents. The server 30 analyzes a subject image and subject information for each subject image, extracts feature information of the subject image including feature information of the projection area, stores an analysis result such as the feature information and the like in the database, and manages the stored analysis result. The database may be included in the server 30 or may be separated from the server 30. The server 30 may provide a list of video contents or a list of subjects, which is managed, to the video contents provider, the subject information provider, or the user. The server 30 may maintain the list of the video contents to be projected for each managed subject or projection area. The video contents provider may select a suitable subject or projection area on which contents thereof are projected with reference to the list of the subjects and provide selection information for designating the video contents and the subject or the projection area to the service provider. The subject information provider may also select video contents which the subject information provider desires to project on a subject thereof or a projection area of the subject with reference to the list of the video contents and provide selection information for designating the subject or the projection area and the video contents to the service provider. The server 30 updates the list of the video contents to be projected on the corresponding subject or the projection area of the subject according to the selection information.

The user photographs a particular subject near the user by using a user terminal 41 and obtains an image. In the following description, the image obtained through the user terminal 41 is referred to as a user image. The user image may be a real time image photographed by the camera mounted to the user terminal 41. For example, referring to FIG. 1, the user photographs the subject existing in the subject image 13 already provided by the subject information provider by using the user terminal 41 and obtains a user image 42. It is preferable that the user terminal 41 has a function of obtaining current position information, camera direction information, information on a distance from the subject, and information on a camera angle. A service client for the video contents service according to the present invention is installed in the user terminal 41, and the user terminal 41 may receive the video contents service according to the present invention in a state where the service client is activated. When an image is photographed in the state where the service client is activated, the user terminal 41 transmits the position and direction information, the distance information, and the camera angle information to the server 30. The user terminal 41 transmits the feature information obtained by analyzing the user image to the server 30. As described above, when the user image is the real time image, the information is generally converted in real time, so that it is preferable that the user terminal 41 periodically transmits the information in real time to the server 30.

The server 30 determines whether there is an area corresponding to the projection area of the subject image managed by the server 30 in the image photographed by the current user terminal 41 based on the position and direction information, the distance information, and the camera angle information received from the user terminal 41. In the following description, the area corresponding to the projection area of the subject image in the user image is referred to as a “corresponding area”. Existence of the corresponding area in the user image means that the subject shown in the user image includes all parts of the subject corresponding to the projection area. For example, referring to FIG. 1, the user image 42 includes all parts of the subject corresponding to the projection area 14 of the subject image 13. That is, there is a corresponding area 43 of the projection area 14 in the user image 42. In some cases, it may be considered that the corresponding area exists when the subject shown in the user image includes all parts of the subject corresponding to the projection area and also when the subject includes a predetermined percentage or more of the subject corresponding to the projection area. Existence or nonexistence of the corresponding area in the user image may be determined by comparing the position and direction information, the distance information, the camera angle information received from the user terminal 41 with position and direction information, distance information, and camera angle information while photographing the subject included in the subject information. For example, when a position of the user terminal 41 is within a predetermined range based on a photographing position of any subject and when a direction, a distance, and an angle of the user terminal 41 are within a predetermined similar range to the photographing direction, the distance, and the angle of the subject, it may be determined that there is the corresponding area in the user image.

When it is determined that there is the corresponding area in the user image, the server 30 selects video contents to be projected on a corresponding area of the user image and provides the selected video contents to the user terminal 41. As described above, when the video contents to be projected on the projection area of the subject are predetermined, the video contents are selected. When there is a plurality of video contents to be projected, a list of the video contents is provided to the user, and the user may select a particular content. Since a reference to select the video contents (for example, rotationally according to a predetermined order) is prepared in advance, the server 30 may select the video contents according to the reference.

When the video contents are selected, the server 30 calculates conversion information indicating a relation between the projection area of the subject image and the corresponding area of the user image in order to enable the user terminal 41 to synthesize the user image and the video contents in a form in which the video contents are projected on the corresponding area of the user image, and transmits the calculated conversion information to the user terminal 41. The conversion information may be calculated based on the feature information of the subject image including the feature information of the projection area and the feature information of the user image received from the user terminal 41. The conversion information may be, for example, a conversion matrix indicating a rotation, a size, or a distortion of a predetermined area within the image.

The user terminal 41 having received the conversion information and the video contents synthesizes the user image and the video contents in a form in which the video contents are projected on the corresponding area of the user image based on the conversion information. To this end, in an exemplary embodiment, the user terminal 41 calculates the corresponding area from the user image by using the conversion information, deforms or distorts a video frame in accordance with a size and a shape of the corresponding area, and then overlays the deformed video frame with the corresponding area of the user image. As described above, when the user image is the real time image, the conversion information received from the server 30 and the corresponding area within the user image are converted in real time, so that deformation aspects may vary depending on each video frame. FIG. 1 shows a synthetic image 44 generated by synthesizing the user image 42 and the video contents 23.

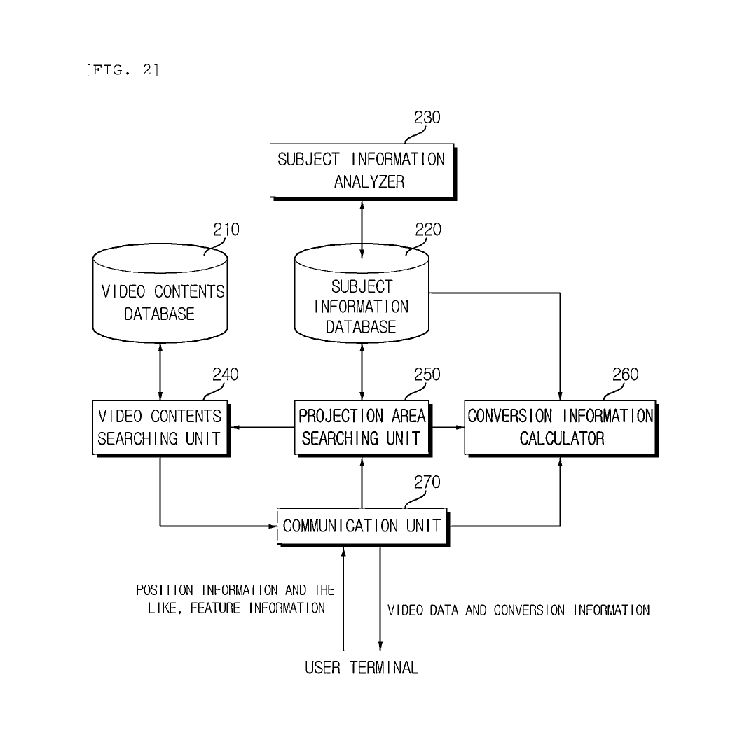

FIG. 2 illustrates a configuration of a video contents providing apparatus according to an exemplary embodiment of the present invention. The video contents providing apparatus according to the present exemplary embodiment includes a video contents database 210, a subject information database 220, a subject information analyzer 230, a video contents searching unit 240, a projection area searching unit 250, a conversion information calculator 260, and a communication unit 270. Some or all of the components of the video contents providing apparatus according to the present exemplary embodiment are included in the server 30. For example, the video contents database 210 and the subject information database 220 may be separated from the server 30.

The video contents database 210 stores video contents provided from the video contents providers. The video contents database 210 also can maintain the list of the video contents.

The subject information database 220 stores subject images provided from the subject information providers, and subject information such as position and direction information corresponding to each subject image, distance information, and information on the projection area. The subject information database 220 also may maintain the list of the subject images or the projection areas. The subject information database 220 also may maintain the list of the video contents to be projected on each subject image or projection area.

Although the video contents database 210 and the subject information database 220 are configured as separate databases in the present embodiment, the video contents database 210 and the subject information database 220 may be configured as one database.

The subject information analyzer 230 analyzes information on the subject image and the projection area for each subject image of the subject information database 220 to extract feature information of the subject image including feature information of the projection area. For example, the subject information analyzer 230 may analyze the subject image by using an object recognition algorithm. An analysis result of feature information of each subject image is stored in the subject information database 220. The communication unit 270 receives position and direction information of the user terminal, information on a distance from the subject, and camera angle information from the user terminal. The communication unit 270 receives the feature information obtained by analyzing the user image from the user terminal.

The projection area searching unit 250 searches for the subject image where the corresponding area of the projection area exists in the user image among subject images managed by the subject information database 220 and the projection area based on the position and direction information, the distance information, and the camera angle information received from the user terminal. The projection area searching unit 250 may determine whether there is the corresponding area in the user image by comparing the position and direction information, the distance information, and the camera angle information received from the user terminal with position and direction information, distance information, and camera angle information while photographing the subject included in the subject information. For example, when the position of the user terminal is within a predetermined range based on the photographing position of any subject and when the direction, the distance, and the angle of the user terminal are within a predetermined similar range to the photographing direction, the distance, and the angle of the subject, it may be determined that there is the corresponding area in the user image.

When it is determined that there is the corresponding area corresponding to the projection area of any subject image in the user image, the video contents searching unit 240 searches for contents to be projected on the projection area of the subject image in the video contents database 210. According to cases, the video contents searching unit 240 searches for a plurality of contents, and may make a request for selecting particular contents from the found contents from the user through the communication unit 270. Video data corresponding to the found (or selected) video contents are transmitted to the user terminal through the communication unit 270. At this time, the video data may be transmitted in a streaming type.

When the contents to be projected on the projection area of the subject image are searched by the video contents searching unit 240, the conversion information calculator 260 calculates conversion information indicating a relation between the projection area of the subject image and the corresponding area of the user image in order to project the video contents on the corresponding area of the user image. The conversion information may be calculated based on the feature information of the subject image including the feature information of the projection area and the feature information of the user image received from the user terminal. For example, the conversion information calculator 260 calculates an area having a similar feature to that of the projection area of the subject image from the user image by comparing features of the projection area of the subject image and features of the user image, and obtains conversion information between the projection area and the calculated area. The conversion information may be, for example, a conversion matrix indicating a rotation, a size, or a distortion of a predetermined area within the image. The conversion information calculator 260 transmits the calculated conversion information to the user terminal through the communication unit 270.

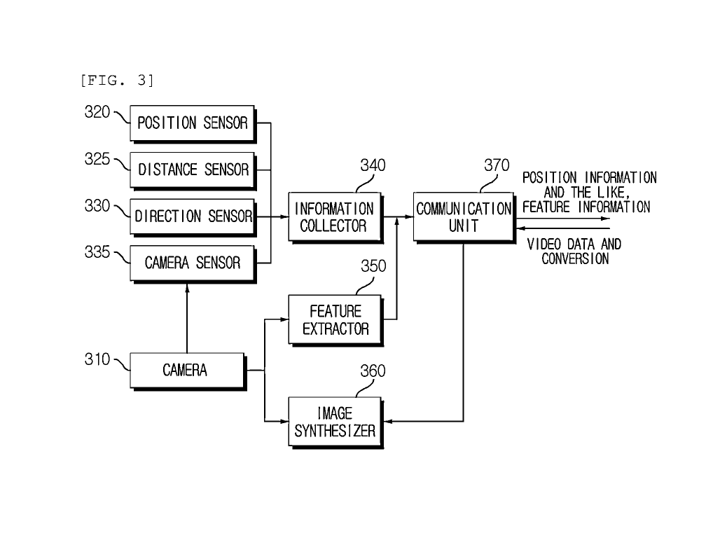

FIG. 3 illustrates a configuration of the user terminal according to an exemplary embodiment of the present invention. The user terminal according to the present exemplary embodiment includes a camera 310, a position sensor 320, a distance sensor 325, a direction sensor 330, a camera sensor 335, an information collector 340, a feature extractor 350, an image synthesizer 360, and a communication unit 370. As described above, the service client for the video contents service according to the present invention may be installed in the user terminal. In this case, functions of some of the components included in the user terminal according to the present exemplary embodiment may be provided by the service client. For example, functions of the information collector 340, the feature extractor 350, and the image synthesizer 360 may be provided by the service client.

The camera 310 photographs an image. In an exemplary embodiment, the camera 310 photographs the image when the service client is activated.

The position sensor 320 obtains current position information of the user terminal. The position sensor 320 may be, for example, a general GPS sensor.

The distance sensor 325 obtains distance information of the subject photographed by the camera 310.

The direction sensor 330 obtains direction information indicating a photographing direction of the camera 310. According to cases, the photographing direction of the camera 310 is equal to a reference direction of the user terminal, or may be easily derived from the reference direction of the user terminal.

The camera sensor 335 obtains angle information indicating a photographing angle of the camera 310. The photographing angle of the camera is, for example, an angle with respect to a horizontal surface or a vertical surface.

The information collector 340 collects information obtained by the sensors 320, 325, 330, and 335, and transmits the collected information to the server through the communication unit 370.

The feature extractor 350 analyzes the image photographed by the camera 310 to extract feature information, and transmits the feature information to the server through the communication unit 370. The image analyzed by the feature extractor 350 may be a real time image photographed by the camera 310. In this case, since the image photographed by the camera 310 is converted in real time, it is preferable that the feature extractor 350 periodically analyzes the currently photographed image to extract feature information and transmits the feature information to the server.

Meanwhile, the communication unit 370 receives video data, and conversion information indicating the relation between the projection area of the subject image found by the server and the corresponding area of the user image from the server.

The image synthesizer 360 synthesizes the user image and the video so that the video contents are projected on the corresponding area of the photographed user image based on the conversion information received from the server. To this end, in an exemplary embodiment, the image synthesizer 360 calculates the corresponding area from the user image by using the conversion information, and deforms or distorts a video frame of the video data in accordance with a size and a shape of the corresponding area. The image synthesizer 360 overlays the deformed video frame with the corresponding area of the user image. As described above, when the user image is the real time image, the conversion information received from the server and the corresponding area within the user image are also converted in real time, so that deformation aspects may be changed according to each video frame.

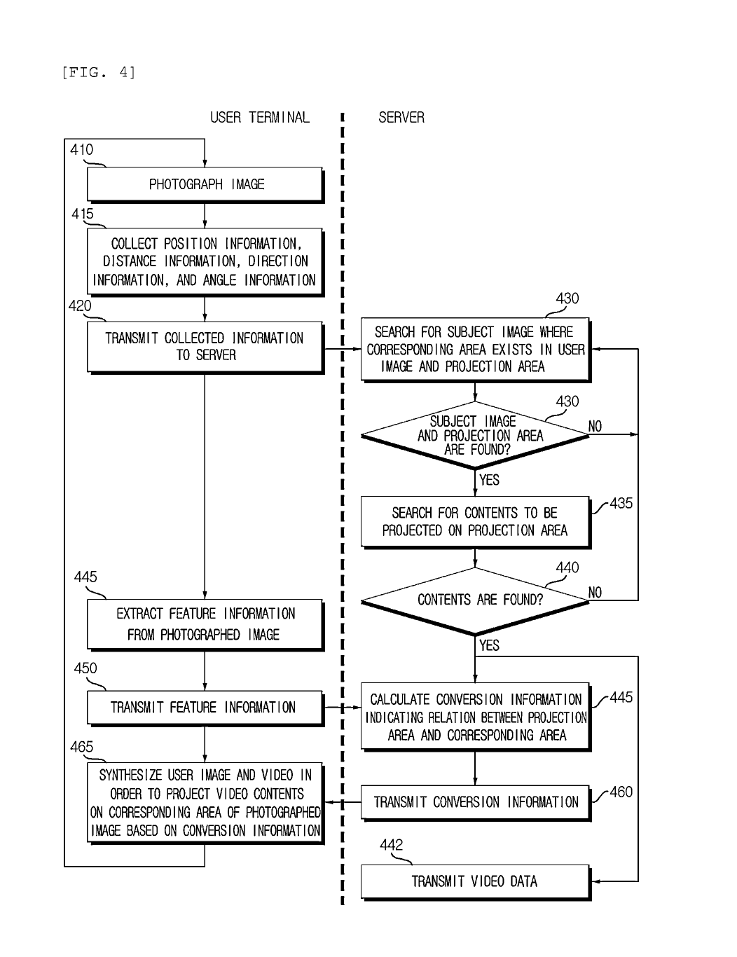

FIG. 4 is a flowchart illustrating a video contents service providing method according to an exemplary embodiment of the present invention.

In step 410, the user terminal photographs an image by using the camera.

In step 415, the user terminal collects current position information of the user terminal, subject distance information, photographing direction information, and camera angle information.

In step 420, the user terminal transmits the information collected in step 415 to the server.

In step 425, the server having received the information searches for the subject image where the corresponding area of the projection area exists in the user image among subject images, and the projection area based on the received information. The server may determine whether there is the corresponding area in the user image by comparing the position and direction information, the distance information, and the camera angle information received from the user terminal with the position and direction information, the distance information, and the camera angle information while photographing the subject included in the subject information. For example, when the position of the user terminal is within a predetermined range based on the photographing position of any subject and when the direction, the distance, and the angle of the user terminal are within a predetermined similar range to the photographing direction, the distance, and the angle of the subject, it may be determined that there is the corresponding area in the user image.

When the subject image and the projection area are not found in step 430, the process returns to step 425 where the server determines whether there is the area corresponding to the projection area of any subject image in the user image photographed by the user terminal based on newly received information.

When the subject image and the projection area are found in step 430, the server searches for contents to be projected on the projection area of the subject image in step 435.

When the contents are not found in step 440, the process returns back to step 425 where the server determines whether there is the area corresponding to the projection area of any subject image in the user image photographed by the user terminal based on newly received information.

When the contents are found in step 440, the server transmits video data to the user terminal in step 442.

At this time, the video data may be transmitted in a streaming type.

Meanwhile, the user terminal analyzes the photographed user image and extracts feature information in step 445.

The user terminal transmits the feature information to the server in step 450.

In step 455, the server having received the feature information calculates conversion information indicating a relation between the projection area of the subject image and the corresponding area of the user image in order to project the video contents on the corresponding area of the user image. The conversion information may be calculated based on feature information of the subject image including feature information of the projection area and feature information of the user image received from the user terminal. For example, the server calculates an area having a similar feature to that of the projection area of the subject image from the user image by comparing features of the projection area of the subject image and features of the user image, and obtains conversion information between the projection area and the calculated area. The conversion information may be, for example, a conversion matrix indicating a rotation, a size, or a distortion of a predetermined area within the image.

In step 460, the server transmits the conversion information to the user terminal.

In step 465, the user terminal having received the conversion information synthesizes the user image and the video so that the video contents are projected on the corresponding area of the user image photographed based on the received conversion information. To this end, in an exemplary embodiment, the user terminal calculates the corresponding area from the user image by using the conversion information, deforms or distorts a video frame of the video data in accordance with a size and a shape of the corresponding area, and then overlays the deformed video frame with the corresponding area of the user image. In the above described exemplary embodiment, when the subject is not within a camera's view according to the position and motion of the user terminal, the conversion information cannot be received from the server, so that the video cannot be synthesized (step 465). In this case, the user terminal may stop reproducing the video contents, but when the video streaming is already initiated through step 442, the user terminal may stop photographing the image and reproduce the received video contents through an entire screen.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of providing a video contents service comprising:
calculating conversion information indicating a relation between a projection area and an area corresponding to the projection area in order to project video contents on the area corresponding to the projection area which is a partial area within a prepared image in a user image photographed by a user terminal; and
transmitting the calculated conversion information to the user terminal.

2. The method of claim 1, wherein the prepared image is an image generated by photographing a particular subject, and the projection area is at least a partial area of the subject.

3. The method of claim 2, wherein the user image is an image generated by photographing the subject, and the area corresponding to the projection area is an area corresponding to the partial area of the subject in the user image.

4. The method of claim 2, further comprising:
preparing photographing position information and photographing direction information of the image generated by photographing the subject in advance, and receiving position information and direction information of the user terminal from the user terminal; and
determining whether the area corresponding to the projection area exists in the user image by comparing position information and direction information of the user terminal with the photographing position information and photographing direction information.

5. The method of claim 2, further comprising:
searching for video contents to be projected on the subject.

6. The method of claim 1, wherein information on the projection area is prepared in advance.

7. The method of claim 1, further comprising:
receiving feature information of the user image from the user terminal,
wherein the calculating of the conversion information comprises calculating the conversion information based on the feature information of the user image and feature information of the projection area.

8. The method of claim 1, wherein the conversion information is a conversion matrix.

9. An apparatus for providing a video contents service comprising:
a conversion information calculator configured to calculate conversion information indicating a relation between a projection area and an area corresponding to the projection area in order to project video contents on the area corresponding to the projection area, which is a partial area within a prepared image from a user image photographed through a user terminal; and
a communication unit configured to transmit the calculated conversion information to the user terminal.

10. The apparatus of claim 9, wherein the prepared image in advance is a subject image generated by photographing a particular subject, and the projection area is at least a partial area of the subject.

11. The apparatus of claim 10, wherein the user image is an image generated by photographing the subject, and the area corresponding to the projection area is an area corresponding to a partial area of the subject in the user image.

12. The apparatus of claim 10, further comprising:
a database configured to store a subject image, photographing position information, and photographing direction information; and
a projection area searching unit configured to search for a subject image where the area corresponding to the projection area exists in the user image and the projection area in the database by comparing the position information and the direction information of the user terminal received from the user terminal with the photographing position information and the photographing direction information.

13. The apparatus of claim 12, wherein the database further stores information on the projection area.

14. The apparatus of claim 9, wherein the conversion information calculator calculates the conversion information based on feature information of the user image received from the user terminal and feature information of the projection area.

15. A method of reproducing video contents of a user terminal, the method comprising:
obtaining an image by photographing a particular subject;
receiving conversion information indicating a relation between a projection area which is a partial area of the subject within an image of a prepared subject in advance and an area corresponding to the projection area within the obtained image; and
synthesizing the obtained image and video data in order to project video contents on the area corresponding to the projection area within the obtained image by using the conversion information.

16. The method of claim 15, further comprising:
transmitting position information and direction information of the user terminal.

17. The method of claim 15, further comprising:
extracting feature information from the obtained image and transmitting the extracted feature information,
wherein the conversion information is calculated based on feature information of the obtained image and feature information of the projection area.

18. The method of claim 15, wherein the synthesizing of the obtained image and the video data comprises calculating the area corresponding to the projection area from the obtained image by using the conversion information and deforming the video data to overlay the deformed video data with the area corresponding to the projection area.
